(19) United States
(12) Patent Application Publication
(10) Pub. No.: US 2022/0405372 A1
(43) Pub. Date: Dec. 22, 2022

(54) BIOMETRIC AUTHENTICATION BASED ON LEARNING PARITY WITH NOISE

(71) Applicants: Siavash Bayat-Sarmadi, Tehran (IR); Shahriar Ebrahimi, Tehran (IR)

(72) Inventors: Siavash Bayat-Sarmadi, Tehran (IR); Shahriar Ebrahimi, Tehran (IR)

(73) Assignee: Sharif University of Technology, Tehran (IR)

(21) Appl. No.: 17/893,663

(22) Filed: Aug. 23, 2022

Related U.S. Application Data
(63) Continuation-in-part of application No. PCT/IB2022/050165, filed on Jan. 11, 2022.
(60) Provisional application No. 63/135,759, filed on Jan. 11, 2021.

(51) Int. Cl. G06F 21/32; H04L 9/32; G06F 9/448

(52) U.S. Cl. CPC G06F 21/32; H04L 9/3236; G06F 9/4498

(57) ABSTRACT

A logic circuit for biometric authentication based on learning parity with noise. The logic circuit includes a sensor. The sensor is configured to acquire a biometric signal. The logic circuit is configured to generate a response signal from the biometric signal by implementing a finite state machine (FSM).

### CROSS-REFERENCE TO RELATED APPLICATION

This application is a continuation-in-part of International Patent Application PCT/IB2022/050165, filed on Jan. 11, 2022, and entitled “BIOMETRIC AUTHENTICATION BASED ON LEARNING PARITY WITH NOISE,” which takes priority from U.S. Provisional Patent Application Ser. No. 63/135,759 filed on Jan. 11, 2021, and entitled “LIGHTWEIGHT FUZZY EXTRACTOR BASED ON LPN FOR IOT”, which are all incorporated herein by reference in their entirety.

### TECHNICAL FIELD

The present disclosure generally relates to fuzzy extraction (FE), and particularly, to hardware implementation of computational fuzzy extractors.

### BACKGROUND

To ensure confidentiality and privacy of users and their associated data in internet of things (IoT), different security protocols may be required that rely on at least a few cryptographic secret/private keys. Secure storage and management of such keys may be very expensive or impractical for many IoT devices. In addition, considering distributed and remote structures of IoT end-nodes, pre-stored secret keys may be extractable by employing physical attacks to device memories.

In order to overcome issues related to secure key-management, many studies have suggested employing user or device biometrics for authentication. User biometrics such as fingerprints and iris are unique to each user and may be utilized for both identification and authentication. On devices, physical unclonable functions (PUFs) may act as an almost perfect biometric source unique to each device.

The fuzzy extractor (FE) concept has been disclosed as a function that may extract cryptographically random and reproducible secure keys from noisy biometric inputs with some loss of entropy. Thus, FEs may be employed in different scenarios where secret key storage may not be available. Such scenarios include constrained resources and limited power/energy consumption, high-security level forbidding secret key storage, and preserving users' privacy. Generally, FE schemes include two phases of generation and reproduction. A generation phase may be executed once during a manufacturing process and may produce a pair of challenge and response from a biometric input such. On the other hand, a reproduction phase may regenerate the same response given helper and biometric data from a same source (with some noise threshold).

Different authentication methods have been disclosed based on traditional FE schemes. However, these methods include software calculations that may be vulnerable to since software based attacks that may break system integrity and exploit biometric sources. Furthermore, the security of traditional FE schemes may be based on information-theoretic setting which may result in large amount of entropy loss. Therefore, traditional FE schemes may require large helper data and assume different characteristics on a biometric source such as independent and identically distributed (i.i.d) data.

There is, therefore, a need for a hardware-based authentication scheme that may be robust against different kinds of attacks. There is further a need for a system for authentication that may consume low hardware resources such as area and power consumption.

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure describes an exemplary logic circuit for biometric authentication based on learning parity with noise. An exemplary logic circuit may include a sensor. An exemplary sensor may be configured to acquire a biometric signal. An exemplary logic circuit may be configured to generate a response signal from the biometric signal by implementing a finite state machine (FSM).

An exemplary FSM may include ten states. An exemplary first state may include generation of an idle output. An exemplary second state may include generation of a reliable index vector from the biometric signal. In an exemplary embodiment, each bit of the reliable index vector may include a respective confidence of a respective bit of the biometric signal. An exemplary third state may include extraction of a subset index vector from the reliable index vector.

An exemplary fourth state may include generation of a modulo 2 addition vector by performing an XOR operation on each of a plurality of selected bit pairs. In an exemplary embodiment, each of the plurality of selected bit pairs may include a first selected bit and a second selected bit. An exemplary first selected bit may be extracted from a respective bit of a helper data according to a respective non-zero bit of the subset index vector. An exemplary second selected bit may be extracted from the biometric signal according to the respective non-zero bit.

An exemplary fifth state may include generation of a primary hash vector from a transposed inverse public key. An exemplary transposed inverse public key may include a primary square matrix. In an exemplary embodiment, generation of the primary hash vector may include sequentially applying a hashing function on each row of the primary square matrix. An exemplary primary square matrix may include a transpose of an inverse of a truncated square matrix. An exemplary truncated square matrix may be extracted from a public key according to the subset index vector. An exemplary public key may include an m×n matrix.

An exemplary sixth state may include verification of the public key. In an exemplary embodiment, the verification of the public key may include obtaining a digestion of the public key by sequentially applying the hashing function on each row of the m×n matrix and comparing the digestion with a pre-stored digestion that may be obtained by applying the hashing function on an original public key.

An exemplary seventh state may include verification of the transposed inverse public key based on the primary hash vector simultaneously with the verification of the public key. In an exemplary embodiment, verification of the transposed inverse public key may include generation of a secondary hash vector from a reloaded inverse public key responsive to applying the hashing function on a k^{th} row of the m×n matrix and a k^{th} element of the subset index vector being non-zero where 1≤k≤m. An exemplary a reloaded inverse public key may include a secondary square matrix. In an exemplary embodiment, generation of the secondary hash vector may include sequentially applying the hashing function on each row of the secondary square matrix. In an exemplary embodiment, verification of the transposed inverse public key may further include comparing the secondary hash vector with the primary hash vector and comparing a multiplication result of the secondary square matrix and the k^{th} row of the m×n matrix with a j^{th} row of an n×n identity matrix where 1≤j≤n responsive to the secondary hash vector being equal to the primary hash vector. Exemplary k^{th} row and j^{th} row may be associated with a j^{th} non-zero element of the subset index vector I″.

An exemplary eighth state may include generation of a secret key by multiplying the inverse of the truncated square matrix by the modulo 2 addition vector. An exemplary ninth state may include verification of the secret key.

An exemplary tenth state may include generation of the response signal by applying the hashing function on a public vector according to the secret key. In an exemplary embodiment, each respective bit of the public vector may be extracted from the helper data according to a respective non-zero bit of the subset index vector.

In an exemplary embodiment, the logic circuit may include a control unit. An exemplary control unit may be configured to transition the FSM from the first state to the second state responsive to the biometric signal being acquired by the sensor. An exemplary control unit may be further configured to transition the FSM from the second state to the third state responsive to the reliable index vector being generated. An exemplary control unit may be further configured to transition the FSM from the third state to the fourth state responsive to the subset index vector being extracted. An exemplary control unit may be further configured to transition the FSM from the fourth state to the fifth state responsive to the modulo 2 addition vector being generated. An exemplary control unit may be further configured to transition the FSM from the fifth state to the sixth state responsive to the primary hash vector being generated. An exemplary control unit may be further configured to transition the FSM from the sixth state to the seventh state responsive to applying the hashing function to the k^{th} row of the m×n matrix and the k^{th} element of the subset index vector being non-zero. An exemplary control unit may be further configured to transition the FSM from the sixth state to the first state responsive to a failure of the verification of the public key. An exemplary control unit may be further configured to transition the FSM from the seventh state to the sixth state responsive to a success of the verification of the transposed inverse public key and transition the FSM from the seventh state to the first state responsive to a failure of the verification of the transposed inverse public key. An exemplary control unit may be further configured to transition the FSM from the sixth state to the eighth state responsive to a success of the verification of the public key. An exemplary control unit may be further configured to transition the FSM from the eighth state to the ninth state responsive to the secret key being generated. An exemplary control unit may be further configured to transition the FSM from the ninth state to the eighth state responsive to an i^{th} successive failure of the verification of the secret key where i<n+1 and transition the FSM from the ninth state to the first state responsive to an (n+1)^{th} successive failure of the verification of the secret key. An exemplary control unit may be further configured to transition the FSM from the ninth state to the tenth state responsive to a success of the verification of the secret key. An exemplary control unit may be further configured to transition the FSM from the tenth state to the first state responsive to the response signal being generated.

An exemplary logic circuit may further include a first shift register, a second shift register, an XOR gate, a third shift register, and a first n-bit register. An exemplary first shift register may be configured to store the helper data and generate a first shifted bit by shifting the helper data one bit per clock cycle. An exemplary second shift register may be coupled to the sensor and may be configured to receive the biometric signal from the sensor and generate a second shifted bit by shifting the biometric signal one bit per clock cycle. An exemplary XOR gate may be configured to perform an XOR operation on the first shifted bit and the second shifted bit. An exemplary third shift register may be configured to store the subset index vector and generate a third shifted bit by shifting the subset index vector one bit per clock cycle. An exemplary first n-bit register may include an enable input. An exemplary enable input may be configured to receive the third shifted bit and generate each respective bit of the modulo 2 addition vector by loading an output of the XOR gate to a respective location in the first n-bit register once per clock cycle responsive to the third shifted bit being non-zero.

An exemplary logic circuit may further include a first hash unit and a second n-bit register. An exemplary first hash unit may be configured to sequentially receive each row of the primary square matrix responsive to the FSM being transitioned to the fifth state, generate the primary hash vector by sequentially applying the hashing function on the each row of the primary square matrix, generate the digestion of the public key by sequentially applying the hashing function on each row of the public key responsive to the FSM being transitioned to the sixth state, sequentially receive each row of the secondary square matrix responsive to the FSM being transitioned to the seventh state, and generate the secondary hash vector by sequentially applying the hashing function on the each row of the secondary square matrix. An exemplary second n-bit register may be coupled to the hash unit and may be configured to store the primary hash vector.

An exemplary logic circuit may further include a third n-bit register and a first comparator circuit. In an exemplary embodiment, the third n-bit register may be configured to store the pre-stored digestion. An exemplary first comparator circuit may be configured to compare the secondary hash vector with the primary hash vector responsive to the secondary hash vector being generated by the first hash unit and compare the digestion of the public key with the pre-stored digestion responsive to the digestion of the public key being generated by the first hash unit.

An exemplary logic circuit may further include a fourth n-bit register, a fifth n-bit register, a first plurality of AND gates, a multi-level XOR tree, a fourth shift register, a fifth shift register, and a second comparator circuit. An exemplary fourth n-bit register may be configured to receive the k^{th} row of the m×n matrix responsive to the secondary hash vector being equal to the primary hash vector. An exemplary fifth n-bit register may be configured to sequentially receive each column of the secondary square matrix responsive to the secondary hash vector being equal to the primary hash vector.

In an exemplary embodiment, the first plurality of AND gates may be configured to generate a first n-bit vector by performing a respective bitwise AND operation on each respective bit in the fourth n-bit register and a respective bit in the fifth n-bit register. An exemplary first n-bit vector may be associated with a respective column of the secondary square matrix. An exemplary multi-level XOR tree may be configured to generate a respective bit of the multiplication result by performing a modulo 2 addition on bits of the first n-bit vector. In an exemplary embodiment, the fourth shift register may be coupled to the multi-level XOR tree and may be configured to sequentially receive each respective bit of the multiplication result from the XOR tree at each clock cycle and generate a fourth shifted bit by shifting the multiplication result one pit per clock cycle.

An exemplary fifth shift register may be configured to store the j^{th} row of the n×n identity matrix and generate a fifth shifted bit by circularly shifting the j^{th} row one bit per clock cycle. An exemplary second comparator circuit configured to compare the multiplication result with the j^{th} row by comparing the fourth shifted bit with the fifth shifted bit.

An exemplary logic circuit may further include a sixth n-bit register, a sixth shift register, a second plurality of AND gates, and a plurality of two-input XOR gates. An exemplary sixth n-bit register may be configured to store the secret key. An exemplary sixth shift register may be coupled to the first n-bit register and may be configured to generate a sixth shifted bit by shifting the modulo 2 addition vector one bit per clock cycle.

In an exemplary embodiment, the second plurality of AND gates may be configured to generate a second n-bit vector by performing bitwise AND operations on the sixth shifted bit and each bit of a respective row of the transposed inverse public key at each clock cycle responsive to the FSM being transitioned to the eighth state. In an exemplary embodiment, the plurality of two-input XOR gates may be configured to generate each bit of the secret key by performing a respective bitwise XOR operation once per clock cycle on each bit of the second n-bit vector and a respective bit in the sixth n-bit register. An exemplary plurality of two-input XOR gates may be further configured to load each bit of the secret key to a respective location in the sixth n-bit register.

In an exemplary embodiment, the verification of the secret key may include generation of a hashed secret key by applying the hashing function on the public vector according to the secret key and comparing the hashed secret key with a pre-stored hashed key.

An exemplary logic circuit may further include a second hash unit and a third comparator circuit. An exemplary second hash unit may be configured to generate the hashed secret key by applying the hashing function to the public vector according to the secret key responsive to the FSM being transitioned to the ninth state. An exemplary third comparator circuit may be configured to compare the hashed secret key with the pre-stored hashed key.

An exemplary logic circuit may further include a third hash unit. An exemplary third hash unit may be configured to generate the response signal by applying the hashing function to the public vector according to the secret key responsive to the FSM being transitioned to the tenth state.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a schematic of a logic circuit for biometric authentication based on learning parity with noise, consistent with one or more exemplary embodiments of the present disclosure.

FIG. 1B shows a block diagram of a logic circuit coupled with a processor, consistent with one or more exemplary embodiments of the present disclosure.

FIG. 1C shows a schematic of a multi-level XOR tree, consistent with one or more exemplary embodiments of the present disclosure.

FIG. 1D shows a schematic of a calculation unit, consistent with one or more exemplary embodiments of the present disclosure.

FIG. 1E shows a schematic of a hash-and-compare unit, consistent with one or more exemplary embodiments of the present disclosure.

FIG. 2 shows a schematic of a finite state machine (FSM), consistent with one or more exemplary embodiments of the present disclosure.

FIG. 3 shows a flowchart of a verification process, consistent with one or more exemplary embodiments of the present disclosure.

FIG. 4 shows a high-level functional block diagram of a computer system, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary logic circuit for biometric authentication based on learning parity with noise. An exemplary logic circuit may implement a finite state machine (FSM). An exemplary FSM may start by loading a biometric signal from a biometric source (such as a fingerprint of a user) and may process the biometric signal through different states to verify and generate appropriate response based on a verification result of the biometric signal. An exemplary FSM may perform only necessary calculations at each state to increase the speed of verification and reduce storage requirements. As a result, an exemplary FSM may perform biometric authentication at a higher speed and may require a less complex hardware compared to traditional biometric authentication schemes. An exemplary logic circuit may implement each state of the FSM utilizing different logic units. By a hardware implementation of biometric authentication, security of an exemplary authentication system may be improved, whereas resource requirement of the authentication process may be decreased.

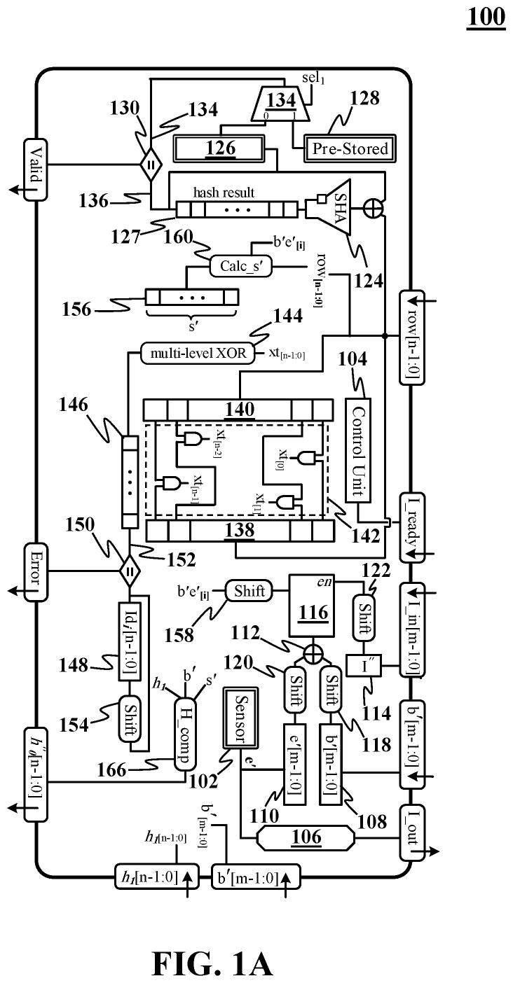

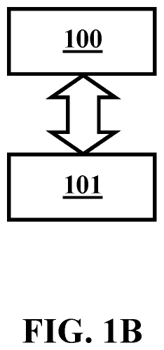

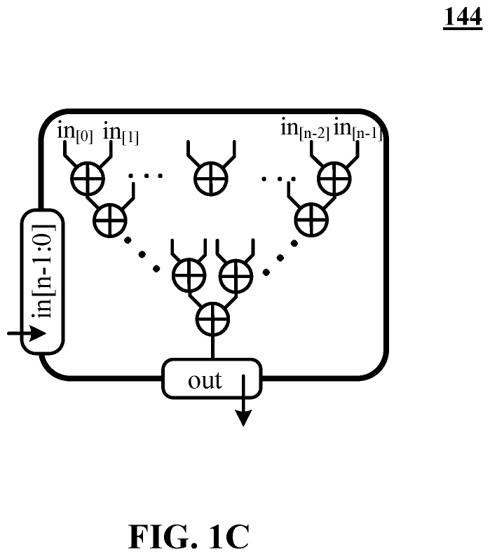

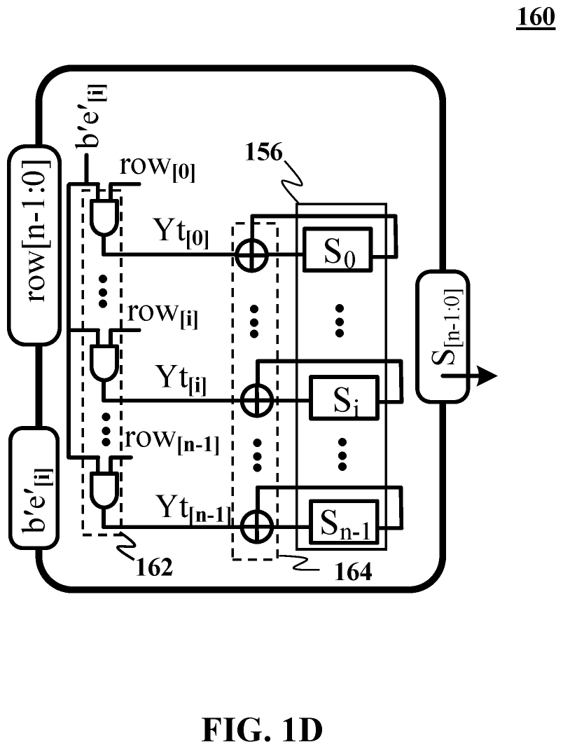

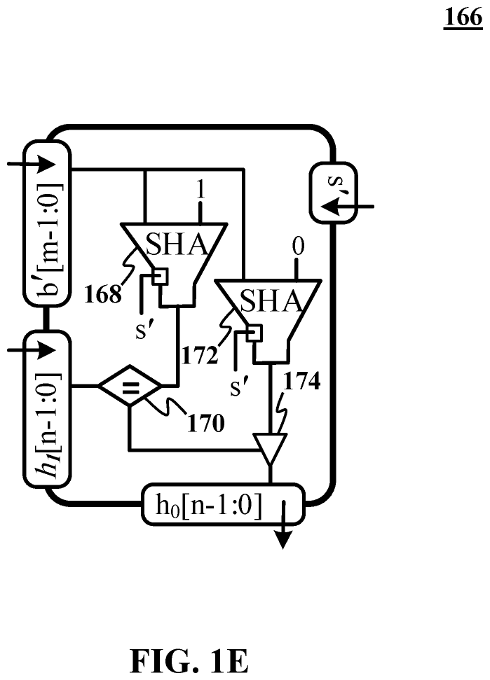

FIG. 1A shows a schematic of a logic circuit for biometric authentication based on learning parity with noise, consistent with one or more exemplary embodiments of the present disclosure. An exemplary logic circuit 100 may include a sensor 102. In an exemplary embodiment, sensor 102 may be a biometric sensor, such as a fingerprint sensor which uses a grid of tiny capacitors that store electricity which is discharged only at points where fingerprint ridges touch. In an exemplary embodiment, sensor 102 may be configured to acquire a biometric signal e′. In an exemplary embodiment, biometric signal e′ may include unique data of a user (such as fingerprints) that may be converted to a digital signal with m bits.

In an exemplary embodiment, logic circuit 100 may be configured to generate a response signal h₀″ from biometric signal e′ by implementing a finite state machine (FSM). In an exemplary embodiment, an FSM may refer to a mathematical model that has a number of states and performs a different action at each state. An exemplary FSM may be transitioned from one state to another based on a specific condition. As a result, an exemplary FSM may accomplish a given task after being transitioned from an initial state to a final state through different middle states.

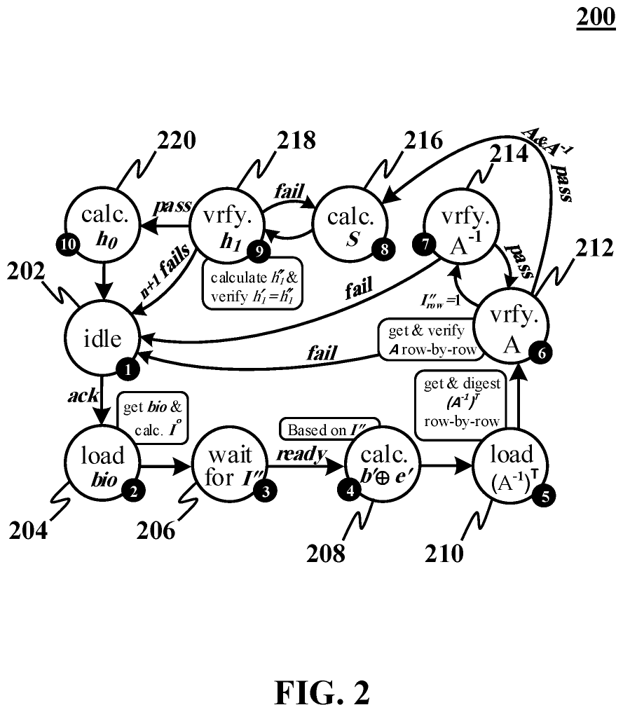

FIG. 2 shows a schematic of an FSM, consistent with one or more exemplary embodiments of the present disclosure. An exemplary FSM 200 may include ten states. An exemplary first state 202 may include generation of an idle output. An exemplary idle output may indicate that logic circuit 100 is waiting for acquisition of biometric signal e′. In an exemplary embodiment, FSM 200 may remain at first state 202 until biometric signal e′ is acquired by sensor 102.

Referring to FIGS. 1A and 2, an exemplary logic circuit may include a control unit 104. In an exemplary embodiment, control unit 104 may be configured to transition FSM 200 from first state 202 to a second state 204 responsive to biometric signal e′ being acquired by sensor 102. In an exemplary embodiment, control unit 104 may generate an acknowledgement signal ack when biometric signal e′ is acquired by sensor 102 to initiate second state 204. In an exemplary embodiment, a “control unit” may refer to a hardware unit that may be programmed (for example, via programmable hardware interconnects) to perform certain functions (such as functions described in the present disclosure) of a logic circuit (for example, logic circuit 100).

In an exemplary embodiment, second state 204 may include generation of a reliable index vector from biometric signal e′. An exemplary reliable index vector I° may include m bits. In an exemplary embodiment, each bit of reliable index vector I° may include a respective confidence of a respective bit of biometric signal e′. In an exemplary embodiment, confidence may refer to a value which may represent which bits of biometric signal e′ may have lower probability of error. An exemplary logic circuit may include a hardware unit 106 that may be configured to generate reliable index vector I° from biometric signal e′. In an exemplary embodiment, different methods may be utilized for generating confidence values of each bit of reliable index vector I°, such as a method disclosed by Herder et al. in “Trapdoor computational fuzzy extractors and stateless cryptographically-secure physical unclonable functions,” IEEE Transactions on Dependable and Secure Computing, vol. 14, no. 1, pp. 65-82, 2016.

In an exemplary embodiment, control unit 104 may be configured to transition FSM 200 from second state 204 to a third state 206 responsive to reliable index vector I° being generated. As a result, in an exemplary embodiment, control unit 104 may initiate third state 206 when hardware unit 106 that obtains reliable index vector I°. In exemplary embodiment, third state 206 may include extraction of a subset index vector I″ from reliable index vector I°. In exemplary embodiment, subset index vector I″ may include n non-zero bits where n≤m. In exemplary embodiment, subset index vector I″ may be utilized to determine n most reliable rows out of a total number of m rows of an m×n matrix A that may have been randomly generated and utilized as an encryption key for encrypting biometric signal e′. In an exemplary embodiment, a reliable row may refer to a row of matrix A that may be included in an n×n truncated square matrix A_{I″} extracted from matrix A to obtain a highest statistical success rate of encryption of biometric signal e′ compared to other possibilities. In an exemplary embodiment, matrix A may be referred to as a public key since it may be exposed to public once it is generated.

FIG. 1B shows a block diagram of a logic circuit coupled with a processor, consistent with one or more exemplary embodiments of the present disclosure. In exemplary embodiment, reliable index vector I° may be sent to a processor 101 that may be configured to obtain subset index vector I″ from reliable index vector I°. In an exemplary embodiment, processor 101 may calculate subset index vector I″ by applying a Gaussian elimination method to matrix A based on reliable index vector I° and a given index vector I′. An exemplary index vector I′ may be a stored version of an original index vector I that may have initially generated from an original biometric signal e to indicate n most reliable bits of original biometric signal e. An exemplary original biometric signal e may have been initially obtained from a same user from whom biometric signal e′ is acquired. However, in an exemplary embodiment, due to various sources of error (such as noise), some bits original biometric signal e and biometric signal e′, and consequently, index vectors I, I°, and I′ may be different. Therefore, subset index vector I″ may be calculated to correct possible inaccuracies in given index vector I′.

Referring again to FIGS. 1A and 2, in an exemplary embodiment, control unit 104 may be configured to transition FSM 200 from third state 206 to a fourth state 208 responsive to subset index vector I″ being extracted. In an exemplary embodiment, processor 101 may notify control unit 104 after generating subset index vector I″ by triggering a ready signal so that control unit 104 may initiate fourth state 208.

In an exemplary embodiment, fourth state 208 may include generation of a modulo 2 addition vector (b′⊕e′)_{I″} by performing an XOR operation on each of a plurality of selected bit pairs. In an exemplary embodiment, each of the plurality of selected bit pairs may include a first selected bit and a second selected bit. An exemplary first selected bit may be extracted from a respective bit of a helper data b′ according to a respective non-zero bit of subset index vector I″. An exemplary second selected bit may be extracted from biometric signal e′ according to the respective non-zero bit.

In further detail regarding fourth state 208, in an exemplary embodiment, modulo 2 addition vector (b′⊕e′)_{I″} may be obtained by performing a modulo 2 addition on helper data b′ and biometric signal e′ according to non-zero bits of subset index vector I″. In an exemplary embodiment, modulo 2 addition may include bitwise addition (i.e., an XOR operation on each pair of bits) of helper data b′ and biometric signal e′. In an exemplary embodiment, helper data b′ may have a same size as biometric signal e′, i.e., m bits. In an exemplary embodiment, helper data b′ may be a stored version of an original helper data b that may have been calculated from an original secret key s and original biometric signal e according to an operation defined by the following:

b_{I}= [symbol] A_{I}·s [symbol] ⊕e_{I} Equation (1)

where b_{I} is an n-bit subset of original helper data b that includes n most reliable bits of original helper data b according to original index vector I, A_{I} is an n×n square matrix that includes n most reliable rows of public key A according to original index vector I, e_{I} is an n-bit subset of original biometric signal e that includes n most reliable bits of origin original biometric signal e according to original index vector I, [symbol] A_{I}·s [symbol] is a bitwise multiplication of A_{I} and s, and ⊕ is a modulo 2 addition operator. In an exemplary embodiment, Equation (1) may be used to hide original secret key s (which is randomly generated) by employing public key A and original biometric signal e. In an exemplary embodiment, original helper data b may be obtained by expanding b_{I} to m bits by inserting zeros based on original index vector I. In an exemplary embodiment, original helper data b may be cryptographically random and therefore, may leak no information about original secret key s and original biometric signal e.

To obtain each exemplary selected bit pair (for example, an i^{th} selected bit pair), a corresponding bit (for example, an i^{th} bit) of subset index vector I″ may be checked. If an exemplary i^{th} bit of subset index vector i^{th} is non-zero, an XOR operation may be performed on the first selected bit (for example, an i^{th} bit of helper data b′) and the second selected bit (for example, an i^{th} bit of biometric signal e′) to obtain a corresponding bit of modulo 2 addition vector (b′⊕e′)_{I″}. Since, in an exemplary embodiment, subset index vector I″ may have n non-zero bits, modulo 2 addition vector (b′⊕e′)_{I″} may have a size of n bits. In other words, in an exemplary embodiment, a j^{th} bit of modulo 2 addition vector (b′⊕e′)_{I″} may correspond to a j^{th} non-zero bit of subset index vector I″. As a result, in an exemplary embodiment, modulo 2 addition vector (b′⊕e′)_{I″} may be generated from n most reliable bits of helper data b′ and biometric signal e′, according to subset index vector I″.

To implement fourth state 208, an exemplary logic circuit may further include a first shift register 108, a second shift register 110, an XOR gate 112, a third shift register 114, and a first n-bit register 116. In an exemplary embodiment, a “register” in the present disclosure refers to a hardware unit that stores digital data (i.e., data bits) and a “shift register” may refer to a register that may shift stored bits to a right or left direction at every clock cycle (typically, one bit per clock cycle). In an exemplary embodiment, first shift register 108 may be configured to store helper data b′ and generate a first shifted bit 118 by shifting helper data b′ one bit per clock cycle. In an exemplary embodiment, second shift register 110 may be coupled to sensor 102 and may be configured to receive biometric signal e′ from sensor 102 and generate a second shifted bit 120 by shifting biometric signal e′ one bit per clock cycle. In an exemplary embodiment, XOR gate 112 may be configured to perform an XOR operation on first shifted bit 118 and second shifted bit 120. In an exemplary embodiment, third shift register 114 may be configured to store subset index vector I″ and generate a third shifted bit 122 by shifting subset index vector I″ one bit per clock cycle. In an exemplary embodiment, first n-bit register 116 may include an enable input en. In an exemplary embodiment, enable input en may be configured to receive third shifted bit 122 and generate each respective bit of modulo 2 addition vector (b′⊕e′)_{I″} by loading an output of XOR gate 112 to a respective location in first n-bit register 116 once per clock cycle responsive to third shifted bit 122 being non-zero 122. In an exemplary embodiment, when third shift register 114 loads the j^{th} non-zero bit of subset index vector I″ to third shifted bit 122, enable input en may be activated. As a result, first n-bit register 116 may receive a result of an XOR operation on first shifted bit 118 and second shifted bit 120. Therefore, in an exemplary embodiment, first shifted bit 118 may be equal to the first selected bit when enable input en is active. In addition, in an exemplary embodiment, second shifted bit 120 may be equal to the second selected bit when enable input en is active. As a result, XOR gate 112 may output the j^{th} bit of modulo 2 addition vector (b′⊕e′)_{I″} (corresponding to the j^{th} non-zero bit of subset index vector I″) to a j^{th} bit location in first n-bit register 116. In an exemplary embodiment, it may last m clock cycles to shift all bits of subset index vector I″. Therefore, all bits of modulo 2 addition vector (b′⊕e′)_{I″} may be generated and loaded into first n-bit register 116 after m clock cycles.

In an exemplary embodiment, control unit 104 may be configured to transition FSM 200 from fourth state 208 to a fifth state 210 responsive to modulo 2 addition vector (b′⊕e′)_{I″} being generated. As a result, in an exemplary embodiment, control unit 104 may initiate fifth state 210 after m clock cycles from the initiation of fourth state 208.

In an exemplary embodiment, fifth state 210 may include generation of a primary hash vector from a transposed inverse public key (A_{I″}⁻¹)^{T}. In an exemplary embodiment, transposed inverse public key (A_{I″}⁻¹)^{T} may include a primary square matrix. In an exemplary embodiment, generation of the primary hash vector may include sequentially applying a hashing function on each row of the primary square matrix. An exemplary primary square matrix may include a transpose of an inverse of a truncated square matrix. An exemplary truncated square matrix A_{I″} may be extracted from public key A according to subset index vector I″, as described above.

An exemplary primary square matrix may include a transpose of an inverse public key A_{I″}⁻¹ which is an inverse of truncated square matrix A_{I″} and is used for calculating a secret key s′ according to an operation defined by the following:

s′= [symbol] A_{I″}⁻¹·(b′⊕e′)_{I″} [symbol] Equation (2)

According to Equations (1) and (2), in an exemplary embodiment, secret key s′ may be equal to original secret key s if b′, e′, and I″ are equal to b, e, and I, respectively, and A_{I″}⁻¹ is equal to an inverse of A_{I}. Therefore, in an exemplary embodiment, inverse public key A_{I″}⁻¹ may be loaded from processor 101 to an exemplary logic circuit in fifth state 210 to be verified prior to calculation of secret key s′. To lower the computational complexity of the verification of inverse public key A_{I″}⁻¹, an exemplary logic circuit may acquire transposed inverse public key (A_{I″}⁻¹)^{T} instead of inverse public key A_{I″}⁻¹ in fifth state 210, so that an entire column of inverse public key A_{I″}⁻¹ may be verified at once by loading a corresponding row of transposed inverse public key (A_{I″}⁻¹)^{T} to a hardware register in a single clock cycle.

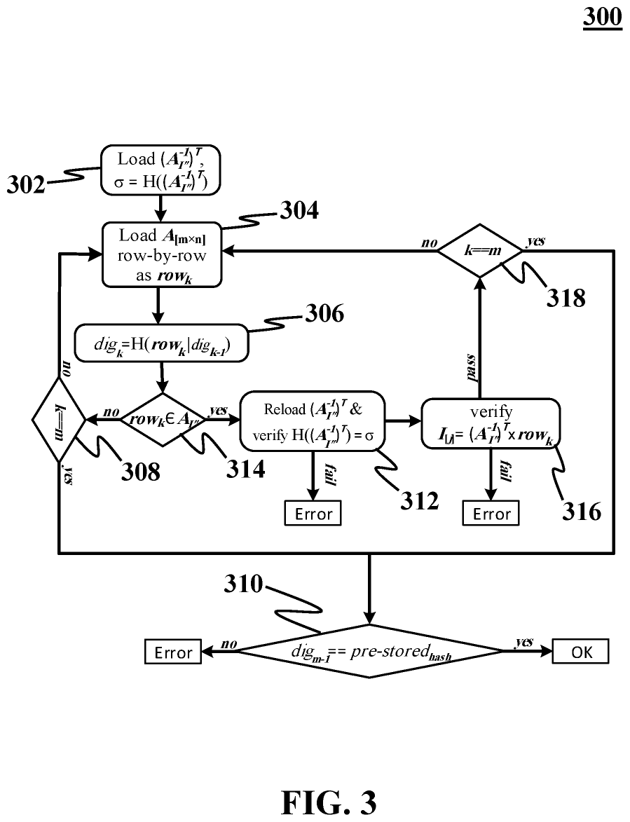

FIG. 3 shows a flowchart of a verification process, consistent with one or more exemplary embodiments of the present disclosure. Referring to FIGS. 2 and 3, in an exemplary embodiment, the verification of inverse public key A_{I″}⁻¹ in fifth state 210 may be performed according to a verification process 300. In an exemplary embodiment, verification process 300 may include loading the primary square matrix row by row and generating a primary hash vector σ by sequentially applying a hashing function on each row of the primary square matrix (step 302). An exemplary hashing function may digest inverse public key A_{I″}⁻¹ column-by-column to a fixed size code. Therefore, in an exemplary embodiment, primary hash vector σ may have a fixed size of n bits, i.e., equal to the size of each row of the primary square matrix. As a result, primary hash vector σ may be saved instead of storing inverse public key A_{I″}⁻¹ for the verification process, thereby reducing required storage space and computational cost. An exemplary hashing function may apply different hashing algorithms to the primary square matrix, such as secure hash algorithm (SHA)-256.

Referring again to FIG. 1A, an exemplary logic circuit may further include a first hash unit 124 and a second n-bit register 126. In an exemplary embodiment, a “hash unit” may refer to a hardware unit that applies hash function (such as SHA-256) to an input data with an arbitrary size to generate a fixed-size output data. In an exemplary embodiment, first hash unit 124 may be configured to sequentially receive each row of the primary square matrix responsive to FSM 200 being transitioned to fifth state 210. As a result, transposed inverse public key (A_{I″}⁻¹)^{T} may be loaded to first hash unit 124 row by row when FSM 200 is transitioned to fifth state 210. In an exemplary embodiment, first hash unit 124 may be further configured to generate primary hash vector σ by sequentially applying the hashing function on each row of the primary square matrix. In an exemplary embodiment, second n-bit register 126 may be coupled to hash unit 124 and may be configured to store primary hash vector σ. An exemplary hashing result of each row of transposed inverse public key (A_{I″}⁻¹)^{T} may be digested into a temporary register 127 at each clock cycle. In an exemplary embodiment, a complete digestion of inverse public key A_{I″}⁻¹ may be provided after n clock cycles to be loaded and stored into second n-bit register 126 from temporary register 127.

Referring again to FIGS. 1A and 2, in an exemplary embodiment, control unit 104 may be further configured to transition FSM 200 from fifth state 210 to a sixth state 212 responsive to primary hash vector σ being generated. As a result, in an exemplary embodiment, control unit 104 may initiate sixth state 212 after n clock cycles from the initiation of fifth state 210.

In an exemplary embodiment, sixth state 212 may include verification of public key A. An exemplary verification of public key A in sixth state 212 may include obtaining a digestion of public key A by sequentially applying the hashing function on each row of the m×n matrix and comparing the digestion with a pre-stored digestion that may be obtained by applying the hashing function on an original public key. In an exemplary embodiment, the original public key may refer to an m×n matrix that may have been initially generated when original biometric signal e was acquired. An exemplary original public key may be equal to public key A if public key A is accurately generated and received by logic circuit 100.

Referring again to FIGS. 2 and 3, in an exemplary embodiment, the verification of public key A in sixth state 212 may be performed according to verification process 300. In an exemplary embodiment, verification process 300 may further include loading matrix A row by row (step 304). To implement an exemplary verification of public key A in sixth state 212, verification process 300 may further include obtaining a digestion of each row of matrix A (step 306) after the row is loaded in step 304. Similar to generating primary hash vector σ, each newly received row of public key A may be hashed to a digestion of a previous row of public key A. An exemplary hashing function (such as SHA-256) may be applied to each row of public key A at each clock cycle. In an exemplary embodiment, a complete digestion of public key A may be provided after m clock cycles. In an exemplary embodiment, if a last row of public key A is hashed (step 308, yes), the digestion may be compared with the pre-stored digestion (step 310). Otherwise, verification process 300 may load a next row of matrix A to continue digesting public key A (step 308, no). In an exemplary embodiment, if the digestion of matrix A is equal to the pre-stored digestion (step 310, yes), verification of matrix A may be successful. Otherwise, in an exemplary embodiment, control unit 104 may be configured to transition FSM 200 from sixth state 212 to first state 202 responsive to a failure of the verification of public key A (step 310, no). As a result, FSM 200 may restart if verification of public key A fails.

Referring again to FIG. 1A, in an exemplary embodiment, first hash unit 124 may be configured to generate the digestion of public key A by sequentially applying the hashing function on each row of the m×n matrix responsive to FSM 200 being transitioned to sixth state 212. An exemplary hashing result of each row of public key A may be digested into a temporary register 127 at each clock cycle. As a result, in an exemplary embodiment, first hash unit 124 may generate a complete digestion of public key A after m clock cycles from the beginning of sixth state 212.

An exemplary logic circuit may further include a third n-bit register 128 and a first comparator circuit 130. In an exemplary embodiment, third n-bit register 128 may be configured to store the pre-stored digestion. In an exemplary embodiment, first comparator circuit 130 may be configured to compare the digestion of public key A with the pre-stored digestion responsive to the digestion of the public key A being generated by first hash unit 124. In an exemplary embodiment, when the digestion of the public key A is generated and stored in temporary register 127 in sixth state 212, control unit 104 may configure a multiplexer 132 through a select line sel₁ of multiplexer 132 to load the pre-stored digestion from third n-bit register 128 to a first input 134 of first comparator circuit 130. In an exemplary embodiment, first comparator circuit 130 may then compare the pre-stored digestion with the digestion of the public key A that is loaded from temporary register 127 to a second input 136 of first comparator circuit 130. If the digestion of the public key A is equal to the pre-stored digestion, comparator circuit 130 may output an exemplary valid signal to control unit 104, indicating that verification of public key A is successful.

Referring again to FIGS. 2 and 3, an exemplary seventh state 214 may include verification of transposed inverse public key (A_{I″}⁻¹)^{T} based on primary hash vector σ simultaneously with verification of public key A to ensure the integrity of a given (A_{I″}⁻¹) that may be generated and sent to logic circuit 100 by processor 101. In an exemplary embodiment, since transposed inverse public key (A_{I″}⁻¹)^{T} is utilized by FSM 200 to obtain secret key s′ for computational efficiency (instead of directly using inverse public key A_{I″}⁻¹ in Equation (2)), (A_{I″}⁻¹)^{T} may be verified in seventh state 214 instead of A_{I″}⁻¹. To verify transposed inverse public key (A_{I″}⁻¹)^{T}, in an exemplary embodiment, verification process 300 may include generation of a secondary hash vector from a reloaded inverse public key (step 312) responsive to applying the hashing function to a k^{th} row (i.e., rowₖ) of the m×n matrix and a k^{th} element of subset index vector I″ being non-zero (step 314, yes) where 1≤k≤m. As a result, an exemplary secondary hash vector may be generated each time the hashing function is applied to a row of public key A that is included in truncated square matrix A_{I″}. An exemplary reloaded inverse public key may include a secondary square matrix. In an exemplary embodiment, if the reloaded inverse public key is correctly generated by processor 101 and accurately loaded to logic circuit 100, the secondary square matrix may be equal to the primary square matrix. Therefore, in an exemplary embodiment, the secondary square matrix may be compared with the primary square matrix by comparing their corresponding hash vectors to verify the reloaded inverse public key, as described below.

In an exemplary embodiment, rows of matrix A that are included in truncated square matrix A_{I″} may be detected in step 314 according to subset index vector I″. In an exemplary embodiment, each non-zero element (for example, the k^{th} element) of subset index vector I″ may indicate the inclusion of a corresponding row (for example, the k^{th} row) of matrix A in truncated square matrix A_{I″}. In an exemplary embodiment, if the k^{th} row of the m×n matrix is included in n×n truncated square matrix A_{I″}, transposed inverse public key (A_{I″}⁻¹)^{T} may be reloaded from processor 101 to logic circuit 100 to verify that an inverse of A_{I″} is correctly generated by processor 101. In an exemplary embodiment, transposed inverse public key (A_{I″}⁻¹)^{T} may be reloaded row by row to obtain the secondary square matrix. Afterward, in an exemplary embodiment, the secondary hash vector may be generated by sequentially applying the hashing function on each row of the secondary square matrix upon reloading each row of transposed inverse public key (A_{I″}⁻¹)^{T} in step 312.

In an exemplary embodiment, verification of a reloaded version of transposed inverse public key (A_{I″}⁻¹)^{T} in step 312 may further include comparing the secondary hash vector with primary hash vector σ. If, in an exemplary embodiment, the secondary hash vector is different from primary hash vector σ, verification of transposed inverse public key (A_{I″}⁻¹)^{T} may fail and FSM 200 may restart from first state 202. Otherwise, verification process 300 may proceed to step 316 to verify a j^{th} row of A_{I″} by comparing a multiplication result (i.e., (A_{I″}⁻¹)^{T}×rowₖ) of the secondary square matrix and the k^{th} row of the m×n matrix with a j^{th} row (IU) of an n×n identity matrix where 1≤j≤n responsive to the secondary hash vector being equal to primary hash vector σ. In an exemplary embodiment, the k^{th} row of the m×n matrix and the j^{th} row of the n×n identity matrix may be associated with a j^{th} non-zero element of the subset index vector I″. In an exemplary embodiment, at each iteration of step 314 in which the k^{th} element of subset index vector I″ is non-zero, the multiplication result may be compared with the j^{th} row of the identity matrix, starting with j=1. If an exemplary multiplication result is equal to the j^{th} row of the identity matrix, j may be incremented by one to examine a next row of A_{I″} in a next iteration of step 316. Therefore, an exemplary j^{th} non-zero element of subset index vector I″ may be the same as the k^{th} element of subset index vector I″ if the k^{th} element of subset index vector I″ is non-zero. In an exemplary embodiment, verification of rows of A_{I″} may be repeated until a last row of public key A is loaded (step 318, yes). If an exemplary multiplication result is different from the j^{th} row of the identity matrix in step 316, verification of A_{I″} (or reloaded matrix (A_{I″}⁻¹)^{T}) may fail, because A_{I″}×A_{I″}⁻¹ may be different from the identity matrix and therefore, an exemplary reloaded matrix A_{I″}⁻¹ may not be considered a correct inverse of matrix A_{I″}. As a result, in an exemplary embodiment, FSM 200 may restart from first state 202. Otherwise, an exemplary verification of transposed inverse public key (A_{I″}⁻¹)^{T} may be successful if all rows of A_{I″} are successfully verified in step 316.

Referring again to FIGS. 1A, 2, and 3, in an exemplary embodiment, control unit 104 may be configured to transition FSM 200 from sixth state 212 to seventh state 214 responsive to applying the hashing function to the k^{th} row (step 306) of the m×n matrix and the k^{th} element of the subset index vector I″ being non-zero (step 314, yes). As a result, in an exemplary embodiment, FSM 200 may be transitioned from sixth state 212 to seventh state 214 each time the hashing function is applied to a row of public key A that is included in truncated square matrix A_{I″}.

In an exemplary embodiment, first hash unit 124 may be further configured to sequentially receive each row of the secondary square matrix from processor 101 responsive to FSM 200 being transitioned to seventh state 214 and generate the secondary hash vector by sequentially applying the hashing function on each row of the secondary square matrix. As a result, in an exemplary embodiment, it may take n clock cycles for seventh state 214 to receive and digest all rows of the secondary square matrix after applying the hashing function to each row of public key A that is included in truncated square matrix A_{I″} in sixth state 212.

In an exemplary embodiment, first comparator circuit 130 may be further configured to implement step 312 of verification process 300 by comparing the secondary hash vector with primary hash vector σ responsive to the secondary hash vector being generated by first hash unit 124. In an exemplary embodiment, when the secondary hash vector is generated and stored in temporary register 127 in seventh state 214, control unit 104 may configure multiplexer 132 through select line sel₁ of multiplexer 132 to load primary hash vector σ from second n-bit register 126 to first input 134 of first comparator circuit 130. In an exemplary embodiment, first comparator circuit 130 may then compare primary hash vector σ with the secondary hash vector that is loaded from temporary register 127 to second input 136 of first comparator circuit 130. If the secondary hash vector is equal to primary hash vector σ, comparator circuit 130 may output an exemplary valid signal to control unit 104, indicating that verification of the reloaded inverse public key is successful.

An exemplary logic circuit may further include a fourth n-bit register 138, a fifth n-bit register 140, a first plurality of AND gates 142, a multi-level XOR tree 144, a fourth shift register 146, a fifth shift register 148, and a second comparator circuit 150. To implement step 316 of verification process 300, in an exemplary embodiment, fourth n-bit register 138 may be configured to receive the k^{th} row of m×n matrix A from processor 101 responsive to the secondary hash vector being equal to primary hash vector σ. An exemplary valid signal may configure fourth n-bit register 138 to receive the k^{th} row of matrix A if the secondary hash vector is equal to primary hash vector σ. In an exemplary embodiment, fifth n-bit register 140 may be configured to sequentially receive each row of the secondary square matrix responsive to the secondary hash vector being equal to primary hash vector σ. An exemplary valid signal may configure fifth n-bit register 140 to receive each row of the secondary square matrix if the secondary hash vector is equal to primary hash vector σ.

To implement the multiplication (A_{I″}⁻¹)^{T}×rowₖ in step 316 of verification process 300, in an exemplary embodiment, first plurality of AND gates 142 may be configured to generate a first n-bit vector Xₜ by performing a respective bitwise AND operation on each respective bit (for example, a j^{th} bit) in fourth n-bit register 138 and a respective bit (for example, a j^{th} bit) in fifth n-bit register 140. In an exemplary embodiment, first n-bit vector Xₜ may be associated with a respective row of the secondary square matrix. Each exemplary bit of first n-bit vector Xₜ may be equal to a bitwise multiplication of a corresponding bit of the k^{th} row of matrix A and a corresponding bit an exemplary row of the secondary square matrix. As a result, in an exemplary embodiment, each row of (A_{I″}⁻¹)^{T} may be convolved with rowₖ in one clock cycle.

FIG. 1C shows a schematic of a multi-level XOR tree, consistent with one or more exemplary embodiments of the present disclosure. In an exemplary embodiment, multi-level XOR tree 144 may have ln (n) layers (for example, 7 layers for n=128) and may be configured to generate a respective bit of the multiplication result at each clock cycle by performing a modulo 2 addition on bits of first n-bit vector 142. In an exemplary embodiment, a j^{th} bit of the multiplication result may correspond to a j^{th} non-zero bit of subset index vector I″, as described above. In an exemplary embodiment, it may take n clock cycles to completely generate the multiplication result in step 316.

In an exemplary embodiment, fourth shift register 146 may be coupled to multi-level XOR tree 144 and may be configured to sequentially receive each respective bit of the multiplication result from the XOR tree at each clock cycle and generate a fourth shifted bit 152 by shifting the multiplication result one pit per clock cycle. In an exemplary embodiment, fifth shift register 148 may be configured to store the j^{th} row of the n×n identity matrix and generate a fifth shifted bit 154 by circularly shifting the j^{th} row one bit per clock cycle. In an exemplary embodiment, second comparator circuit 150 may be configured to compare the multiplication result with the j^{th} row by comparing fourth shifted bit 152 with fifth shifted bit 154. If, in an exemplary embodiment, the multiplication result is different from the j^{th} row of the n×n identity matrix, verification of the transposed inverse public key (A_{I″}⁻¹)^{T} in step 316 may fail, and consequently, control unit 104 may transition FSM 200 from seventh state 214 to first state 202, so that FSM 200 may restart from its initial state. Otherwise, control unit 104 may transition FSM 200 from seventh state 214 to sixth state 212, so that verification process 300 may proceed to verifying a next row of matrix A.

Referring again to FIGS. 1A and 2, in an exemplary embodiment, control unit 104 may be configured to transition FSM 200 from sixth state 212 to an eighth state 216 responsive to a success of the verification of public key A. Therefore, in an exemplary embodiment, control unit 104 may initiate eighth state 216 if matrix A is successfully verified in step 310 of verification process 300. In an exemplary embodiment, eighth state 216 may include generation of secret key s′ by multiplying inverse of the truncated square matrix A_{I″}⁻¹ by modulo 2 addition vector (b′⊕e′)_{I″} according to Equation (2).

To implement eighth state 216, an exemplary logic circuit may further include a sixth n-bit register 156, a sixth shift register 158, and a calculation unit 160. In an exemplary embodiment, sixth n-bit register 156 may be configured to store secret key s′. In an exemplary embodiment, sixth shift register 158 may be coupled to first n-bit register 116 and may be configured to generate a sixth shifted bit b′e′[i] by shifting modulo 2 addition vector (b′⊕e′)_{I″} one bit per clock cycle.

FIG. 1D shows a schematic of a calculation unit, consistent with one or more exemplary embodiments of the present disclosure. In an exemplary embodiment, calculation unit 160 may include a second plurality of AND gates 162 and a plurality of two-input XOR gates 164. In an exemplary embodiment, second plurality of AND gates 162 may include n AND gates. As a result, second plurality of AND gates 162 may be configured to generate a second n-bit vector Yt by performing bitwise AND operations on sixth shifted bit b′e′[i] and each bit of a respective row of transposed inverse public key (A_{I″}⁻¹)^{T} at each clock cycle responsive to FSM 200 being transitioned to eighth state 216. Therefore, for each exemplary row of transposed inverse public key (A_{I″}⁻¹)^{T}, second n-bit vector Yt may be generated once after initiation of eighth state 216 in a single clock cycle. In an exemplary embodiment, plurality of two-input XOR gates 164 may be configured to generate each bit of secret s′ key by performing a respective bitwise XOR operation once per clock cycle on each bit of second n-bit vector Yt and a respective bit in sixth n-bit register 156. In an exemplary embodiment, plurality of two-input XOR gates 164 may be further configured to load each bit of secret key s′ to a respective location in sixth n-bit register 156. For example, an i^{th} bit of secret key s′ may be loaded to an i^{th} location in sixth n-bit register 156 where 0≤i<n. Therefore, at each exemplary clock, the i^{th} bit of secret key s′ may be XORed with a value of the i^{th} bit that may have been generated in a previous clock cycle. In an exemplary embodiment, plurality of two-input XOR gates 164 may include n XOR gates. As a result, all bits of secret key s′ may be XORed with their previous values in a single clock cycle. As a result, an entire calculation of Equation (2) may last n clock cycles (one clock cycle for each row of transposed inverse public key (A_{I″}⁻¹)^{T}).

Referring again to FIGS. 1A and 2, in an exemplary embodiment, control unit 104 may be configured to transition FSM 200 from eighth state 216 to a ninth state 218 responsive to secret key s′ being generated. As a result, FSM 200 may be transitioned to ninth state 218 after n clock cycles from the initiation of eighth state 216. In an exemplary embodiment, ninth state 218 may include verification of secret key s′. In an exemplary embodiment, verification of secret key s′ may include generation of a hashed secret key h₁″ by applying the hashing function to a public vector b_{I″}′ according to secret key s′ and comparing hashed secret key h₁″ with a pre-stored hashed key h₁′.

In an exemplary embodiment, each respective bit of public vector b_{I″}′ may be extracted from helper data b′ according to a respective non-zero bit of subset index vector I″. As a result, in an exemplary embodiment, public vector b_{I″}′ may include n most reliable bits of helper data b′ according to subset index vector I″. In an exemplary embodiment, pre-stored hashed key h₁′ may have been previously generated by processor 101 by applying the hashing function to b_{I} (defined in Equation (1)) according to original secret key s. Therefore, pre-stored hashed key h₁′ may be used for verification of secret key s′ in ninth state 218. If, in an exemplary embodiment, hashed secret key h₁″ is equal to pre-stored hashed key h₁′, secret key s′ may be considered valid. Otherwise, in an exemplary embodiment, verification of secret key s′ may be considered unsuccessful.

To implement ninth state 218, an exemplary logic circuit may further include a hash-and-compare unit 166. FIG. 1E shows a schematic of a hash-and-compare unit, consistent with one or more exemplary embodiments of the present disclosure. In an exemplary embodiment, hash-and-compare unit 166 may include a second hash unit 168 and a third comparator circuit 170. In an exemplary embodiment, second hash unit 168 may be configured to generate hashed secret key h₁″ by applying the hashing function to public vector b_{I″}′ according to secret key s′ when FSM 200 is transitioned to ninth state 218.

In an exemplary embodiment, third comparator circuit 170 may be configured to compare hashed secret key h₁″ with pre-stored hashed key h₁′. If, in an exemplary embodiment, hashed secret key h₁″ is different from pre-stored hashed key h₁′, FSM 200 may be transitioned back to eighth state 216 to recalculate secret key s′ with one bit-flip in modulo 2 addition vector (b′⊕e′)_{I″}. Therefore, in an exemplary embodiment, control unit 104 may be configured to transition FSM 200 from ninth state 218 to eighth state 216 responsive to an i^{th} successive failure of the verification of secret key s′ where i<n+1. Since, in an exemplary embodiment, there may be n possible bit-flips in modulo 2 addition vector (b′⊕e′)_{I″}, FSM 200 may be successively transitioned from ninth state 218 to eighth state 216 until a number of successive failures of verification of secret key s′ reaches n+1. If none of exemplary bit-flips of (b′⊕e′)_{I″} leads to a successful verification of secret key s′, secret key s′ may be considered invalid and logic circuit 100 may generate an error signal. As a result, in an exemplary embodiment, control unit 104 may be configured to transition FSM 200 from ninth state 218 to first state 202 responsive to an (n+1)^{th} successive failure of the verification of the secret key s′, so that FSM 200 may restart from an idle state.

Referring again to FIGS. 1A, 1E, and 3, in an exemplary embodiment, control unit 104 may be further configured to transition FSM 200 from ninth state 218 to a tenth state 220 if secret key s′ is successfully verified in ninth state 218. In an exemplary embodiment, tenth state 220 may include generation of response signal h₀″ by applying the hashing function to public vector b_{I″}′ according to secret key s′.

To implement tenth state 220, in an exemplary embodiment, hash-and-compare unit 166 may further include a third hash unit 172. In an exemplary embodiment, third hash unit 170 may be configured to generate response signal h₀″ by applying the hashing function to public vector b_{I″}′ according to secret key s′ responsive to FSM 200 being transitioned to tenth state 220. In an exemplary embodiment, if hashed secret key h₁″ is equal to pre-stored hashed key h₁′ (i.e., secret key s′ is verified successfully), third comparator circuit 170 may trigger a buffer circuit 174 that is coupled to third hash unit 172 to pass response signal h₀″ as a final output of logic circuit 100. Afterwards, in an exemplary embodiment, control unit 104 may transition FSM 200 from tenth 220 state to first state 202 responsive to response signal h₀″ being generated.

In order to differentiate response signal h₀″ from hashed secret key h₁″ (since they are both generated from public vector b_{I″}′ according to secret key s′), different extra bits may be concatenated to inputs of second hash unit 168 and third hash unit 172. For example, a “1” bit may be concatenated to the input data of second hash unit 168 and a “0” bit may be concatenated to the input data of third hash unit 172. An exemplary concatenation may have to be previously applied to b_{I} for generation of pre-stored hashed key h₁′, so that digestion of secret key s′ may be consistent with that of original secret key s.

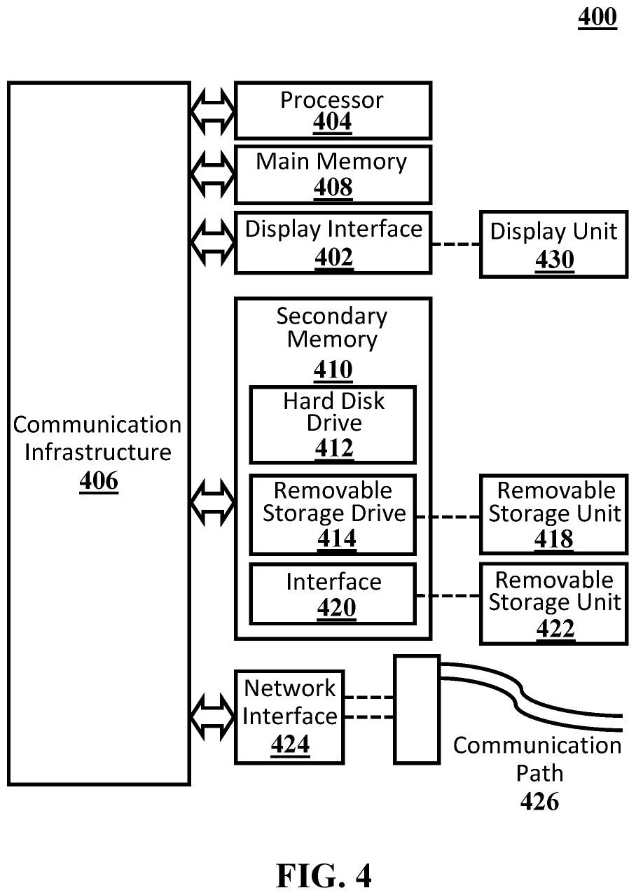

FIG. 4 shows an example computer system 400 in which an embodiment of the present invention, or portions thereof, may be implemented as computer-readable code, consistent with exemplary embodiments of the present disclosure. For example, processor 101 may be implemented in computer system 400 using hardware, software, firmware, tangible computer readable media having instructions stored thereon, or a combination thereof and may be implemented in one or more computer systems or other processing systems. Hardware, software, or any combination of such may embody any of the units and components in FIGS. 1A-3.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the invention is described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 404 may be a special purpose (e.g., a graphical processing unit) or a general-purpose processor device. As will be appreciated by persons skilled in the relevant art, processor device 404 may also be a single processor in a multi-core/multiprocessor system, such system operating alone, or in a cluster of computing devices operating in a cluster or server farm. Processor device 404 may be connected to a communication infrastructure 406, for example, a bus, message queue, network, or multi-core message-passing scheme.

In an exemplary embodiment, computer system 400 may include a display interface 402, for example a video connector, to transfer data to a display unit 430, for example, a monitor. Computer system 400 may also include a main memory 408, for example, random access memory (RAM), and may also include a secondary memory 410. Secondary memory 410 may include, for example, a hard disk drive 412, and a removable storage drive 414. Removable storage drive 414 may include a floppy disk drive, a magnetic tape drive, an optical disk drive, a flash memory, or the like. Removable storage drive 414 may read from and/or write to a removable storage unit 418 in a well-known manner. Removable storage unit 418 may include a floppy disk, a magnetic tape, an optical disk, etc., which may be read by and written to by removable storage drive 414. As will be appreciated by persons skilled in the relevant art, removable storage unit 418 may include a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via a communications path 426. Communications path 426 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 418, removable storage unit 422, and a hard disk installed in hard disk drive 412. Computer program medium and computer usable medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communications interface 424. Such computer programs, when executed, enable computer system 400 to implement different embodiments of the present disclosure as discussed herein. In particular, the computer programs, when executed, enable processor device 404 to implement the processes of the present disclosure, such as the operations in verification process 300 illustrated by flowchart of FIG. 3 discussed above. Accordingly, such computer programs represent controllers of computer system 400. Where an exemplary embodiment of logic circuit 100 is implemented using software, the software may be stored in a computer program product and loaded into computer system 400 using removable storage drive 414, interface 420, and hard disk drive 412, or communications interface 424.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A logic circuit for biometric authentication based on learning parity with noise, the logic circuit comprising a sensor configured to acquire a biometric signal e′ comprising m bits, the logic circuit configured to generate a response signal from the biometric signal e′ by implementing a finite state machine (FSM), the FSM comprising:
a first state comprising generation of an idle output;
a second state comprising generation of a reliable index vector I° comprising m bits from the biometric signal e′, each bit of the reliable index vector I° comprising a respective confidence of a respective bit of the biometric signal e′;
a third state comprising extraction of a subset index vector I″ from the reliable index vector I°, the subset index vector I″ comprising n non-zero bits where n≤m;
a fourth state comprising generation of a modulo 2 addition vector (b′⊕e′)_{I″} comprising n bits by performing an XOR operation on each of a plurality of selected bit pairs, each of the plurality of selected bit pairs comprising a first selected bit extracted from a respective bit of a helper data b′ according to a respective non-zero bit of the subset index vector I″ and a second selected bit extracted from the biometric signal e′ according to the respective non-zero bit;
a fifth state comprising generation of a primary hash vector from a transposed inverse public key (A_{I″}⁻¹)^{T} comprising a primary square matrix by sequentially applying a hashing function on each row of the primary square matrix, the primary square matrix comprising a transpose of an inverse of a truncated square matrix extracted from a public key A according to the subset index vector I″, the public key A comprising an m×n matrix;
a sixth state comprising verification of the public key A;
a seventh state comprising verification of the transposed inverse public key (A_{I″}⁻¹)^{T} based on the primary hash vector simultaneously with the verification of the public key A;
an eighth state comprising generation of a secret key s′ by multiplying the inverse of the truncated square matrix by the modulo 2 addition vector (b′⊕e′)_{I″} a ninth state comprising verification of the secret key s′; and
a tenth state comprising generation of the response signal by applying the hashing function to a public vector b_{I″}′ according to the secret key s′, each respective bit of the public vector b_{I″}′ extracted from the helper data b′ according to a respective non-zero bit of the subset index vector I″.

2. The logic circuit of claim 1, wherein the verification of the public key A comprises:
obtaining a digestion of the public key A by sequentially applying the hashing function to each row of the m×n matrix; and
comparing the digestion with a pre-stored digestion obtained by applying the hashing function on an original public key.

3. The logic circuit of claim 2, wherein the verification of the transposed inverse public key (A_{I″}⁻¹)^{T} comprises:
generation of a secondary hash vector from a reloaded inverse public key comprising a secondary square matrix by sequentially applying the hashing function to each row of the secondary square matrix responsive to:
applying the hashing function on a k^{th} row of the m×n matrix where 1≤k≤m; and
a k^{th} element of the subset index vector I″ being non-zero;
comparing the secondary hash vector with the primary hash vector; and
comparing a multiplication result of the secondary square matrix and the k^{th} row of the m×n matrix with a j^{th} row of an n×n identity matrix where 1≤j≤n responsive to the secondary hash vector being equal to the primary hash vector, the k^{th} row and the j^{th} row associated with a j^{th} non-zero element of the subset index vector I″.

4. The logic circuit of claim 3, wherein the verification of the secret key s′ comprises:
generation of a hashed secret key h₁″ by applying the hashing function on the public vector b_{I″}′, according to the secret key s′; and
comparing the hashed secret key h₁″ with a pre-stored hashed key h₁′.

5. The logic circuit of claim 4, further comprising a control unit configured to:
transition the FSM from the first state to the second state responsive to the biometric signal e′ being acquired by the sensor;
transition the FSM from the second state to the third state responsive to the reliable index vector I° being generated;
transition the FSM from the third state to the fourth state responsive to the subset index vector I″ being extracted;
transition the FSM from the fourth state to the fifth state responsive to the modulo 2 addition vector (b′⊕e′)_{I″} being generated;
transition the FSM from the fifth state to the sixth state responsive to the primary hash vector being generated;
transition the FSM from the sixth state to the seventh state responsive to:
applying the hashing function to the k^{th} row of the m×n matrix; and
the k^{th} element of the subset index vector I″ being non-zero;
transition the FSM from the sixth state to the first state responsive to a failure of the verification of the public key A;
transition the FSM from the seventh state to the sixth state responsive to a success of the verification of the transposed inverse public key (A_{I″}⁻¹)^{T};
transition the FSM from the seventh state to the first state responsive to a failure of the verification of the transposed inverse public key (A_{I″}⁻¹);
transition the FSM from the sixth state to the eighth state responsive to a success of the verification of the public key A;
transition the FSM from the eighth state to the ninth state responsive to the secret key s′ being generated;
transition the FSM from the ninth state to the eighth state responsive to an i^{th} successive failure of the verification of the secret key s′ where i<n+1;
transition the FSM from the ninth state to the first state responsive to an (n+1)^{th} successive failure of the verification of the secret key s′;
transition the FSM from the ninth state to the tenth state responsive to a success of the verification of the secret key s′; and
transition the FSM from the tenth state to the first state responsive to the response signal being generated.

6. The logic circuit of claim 5, further comprising:
a first shift register configured to:
store the helper data b′; and
generate a first shifted bit by shifting the helper data b′ one bit per clock cycle;
a second shift register coupled to the sensor and configured to:
receive the biometric signal e′ from the sensor; and
generate a second shifted bit by shifting the biometric signal e′ one bit per clock cycle;
an XOR gate configured to perform an XOR operation on the first shifted bit and the second shifted bit;
a third shift register configured to:
store the subset index vector I″; and
generate a third shifted bit by shifting the subset index vector I″ one bit per clock cycle; and
a first n-bit register comprising an enable input configured to:
receive the third shifted bit; and
generate each respective bit of the modulo 2 addition vector (b′⊕e′)_{I″} by loading an output of the XOR gate to a respective location in the first n-bit register once per clock cycle responsive to the third shifted bit being non-zero.

7. The logic circuit of claim 6, further comprising:
a first hash unit configured to:
sequentially receive each row of the primary square matrix responsive to the FSM being transitioned to the fifth state;
generate the primary hash vector by sequentially applying the hashing function on the each row of the primary square matrix;
generate the digestion of the public key A by sequentially applying the hashing function on each row of the m×n matrix responsive to the FSM being transitioned to the sixth state;
sequentially receive each row of the secondary square matrix responsive to the FSM being transitioned to the seventh state; and
generate the secondary hash vector by sequentially applying the hashing function on the each row of the secondary square matrix; and
a second n-bit register coupled to the first hash unit and configured to store the primary hash vector.

8. The logic circuit of claim 7, further comprising:
a third n-bit register configured to store the pre-stored digestion; and
a first comparator circuit configured to:
compare the secondary hash vector with the primary hash vector responsive to the secondary hash vector being generated by the first hash unit; and
compare the digestion of the public key A with the pre-stored digestion responsive to the digestion of the public key A being generated by the first hash unit.

9. The logic circuit of claim 8, further comprising:
a fourth n-bit register configured to receive the k^{th} row of the m×n matrix responsive to the secondary hash vector being equal to the primary hash vector;
a fifth n-bit register configured to sequentially receive each row of the secondary square matrix responsive to the secondary hash vector being equal to the primary hash vector;
a first plurality of AND gates configured to generate a first n-bit vector associated with a respective row of the secondary square matrix by performing a respective bitwise AND operation on each respective bit in the fourth n-bit register and a respective bit in the fifth n-bit register;
a multi-level XOR tree configured to generate a respective bit of the multiplication result by performing a modulo 2 addition on bits of the first n-bit vector;
a fourth shift register coupled to the multi-level XOR tree and configured to:
sequentially receive each respective bit of the multiplication result from the XOR tree at each clock cycle; and
generate a fourth shifted bit by shifting the multiplication result one pit per clock cycle;
a fifth shift register configured to:
store the j^{th} row of the n×n identity matrix; and
generate a fifth shifted bit by circularly shifting the j^{th} row one bit per clock cycle; and
a second comparator circuit configured to compare the multiplication result with the j^{th} row by comparing the fourth shifted bit with the fifth shifted bit.

10. The logic circuit of claim 9, further comprising:
a sixth n-bit register configured to store the secret key s′;
a sixth shift register coupled to the first n-bit register and configured to generate a sixth shifted bit by shifting the modulo 2 addition vector (b′⊕e′)_{I″} one bit per clock cycle;
a second plurality of AND gates configured to generate a second n-bit vector by performing bitwise AND operations on the sixth shifted bit and each bit of a respective row of the transposed inverse public key (A_{I″}⁻¹)^{T} at each clock cycle responsive to the FSM being transitioned to the eighth state; and
a plurality of two-input XOR gates configured to:
generate each bit of the secret key s′ by performing a respective bitwise XOR operation once per clock cycle on each bit of the second n-bit vector and a respective bit in the sixth n-bit register; and
load each bit of the secret key s′ to a respective location in the sixth n-bit register.

11. The logic circuit of claim 10, further comprising:
a second hash unit configured to generate the hashed secret key h₁″ by applying the hashing function to the public vector b_{I″}′ according to the secret key s′ responsive to the FSM being transitioned to the ninth state; and
a third comparator circuit configured to compare the hashed secret key h₁″ with the pre-stored hashed key h₁′.

12. The logic circuit of claim 11, further comprising a third hash unit configured to generate the response signal by applying the hashing function to the public vector b′n according to the secret key s′ responsive to the FSM being transitioned to the tenth state.
